(19) United States
(12) Patent Application Publication
(10) Pub. No.: US 2026/0128772 A1
(43) Pub. Date: May 7, 2026

(54) WLAN SPATIAL NULLING

(71) Applicant: MaxLinear, Inc., Carlsbad, CA (US)

(72) Inventors: Rainer Strobel, München (DE); Avi Avraham Mansour, Givat-Shmuel (IL); Ziv Avital, Kadima (IL); Sigurd Schelstraete, Menlo Park, CA (US)

(73) Assignee: MaxLinear, Inc., Carlsbad, CA (US)

(21) Appl. No.: 19/382,168

(22) Filed: Nov. 6, 2025

Related U.S. Application Data
(60) Provisional application No. 63/717,276, filed on Nov. 6, 2024.

(51) Int. Cl. H04B 7/06; H04W 84/12

(52) U.S. Cl. CPC H04B 7/0619; H04W 84/12

(57) ABSTRACT

An access point (AP) may include a transceiver and a processing device. The transceiver may be operable to communicate with at least a second AP and at least a first station (STA). The processing device may be operable to transmit a null data packet announcement and a joint null data packet from the AP and the second AP. The processing device may also be operable to request a sounding feedback from the first STA. The processing device may further be operable to obtain a channel estimation feedback from the second AP. The processing device may also be operable to perform a precoder calculation using the sounding feedback and the channel estimation feedback. The processing device may further be operable to provide the precoder calculation to the second AP.

### CROSS REFERENCE TO RELATED APPLICATIONS

This U.S. patent application claims priority to U.S. Provisional Patent Application No. 63/717,276, titled “WLAN SPATIAL NULLING,” and filed on Nov. 6, 2024, the disclosure of which is hereby incorporated by reference in its entirety.

### TECHNICAL FIELD

This disclosure generally relates to wireless communication, and more specifically, to spatial nulling in a wireless local area network.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.11 standards include protocols for implementing wireless local area network (WLAN) communications, including Wi-Fi®. Multiple access point coordination is a key feature of ultra-high reliability (UHR) WLAN. Spatial re-use with spatial nulling may increase spectral efficiency as spatial reuse may allow simultaneous transmission in the same frequency band from multiple access points (APs). Multiple-input and multiple-output (MIMO) precoding techniques may be used to suppress interference between neighboring WLAN networks (overlapping basic service sets (OBSS)), which is called spatial nulling.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, an access point (AP) may include a transceiver and a processing device. The transceiver may be operable to communicate with at least a second AP and at least a first station (STA). The processing device may be operable to transmit a null data packet announcement (NDPA) and a joint null data packet (NDP) from the AP and the second AP. The processing device may also be operable to request a sounding feedback from the first STA. The processing device may further be operable to obtain a channel estimation feedback from the second AP. The processing device may also be operable to perform a precoder calculation using the sounding feedback and the channel estimation feedback. The processing device may further be operable to provide the precoder calculation to the second AP.

In another embodiment, an access point (AP) may include a transceiver and a processing device. The transceiver may be operable to communicate with at least a second AP and at least a first STA. The processing device may be operable to transmit a null data packet announcement and a joint null data packet from the AP. The processing device may also be operable to obtain a sounding feedback from the first STA in response to the first NDPA and the first NDP. The processing device may further be operable to transmit a nulling report poll (RP) to a second STA. The processing device may also be operable to obtain a first nulling feedback from the second STA in response to the nulling RP. The processing device may further be operable to cause a transmission of a second NDPA and a second NDP from the second AP. The second AP may obtain a second channel estimation feedback from the second STA and a second nulling feedback from the first STA. The processing device may also be operable to determine an equalizer for the first STA based on the sounding feedback, the first nulling feedback, the second channel estimation feedback, and the second nulling feedback.

In another embodiment, a method may include transmitting an NDPA and an NDP from an AP to a second AP. The method may also include requesting a sounding feedback from a first STA associated with the AP. The method may further include obtaining a channel estimation feedback from the second AP. The method may also include performing a precoder calculation using the sounding feedback and the channel estimation feedback. The method may further include providing the precoder calculation to the second AP.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates an example system for wireless local area network (WLAN) spatial nulling using joint sounding;

FIG. 2 illustrates an example system for WLAN spatial nulling using joint sounding with a single null data packet (NDP) transmission;

FIGS. 3A and 3B illustrate an example system for WLAN spatial nulling using joint sounding with a double NDP transmission;

FIG. 4 illustrates an example system for a null data packet announcement (NDPA) trigger without spatial nulling;

FIGS. 5A and 5B illustrate an example system for WLAN spatial nulling using independent sounding;

FIGS. 6A and 6B illustrate an example system for WLAN spatial nulling using independent sounding and a double NDP transmission;

FIGS. 7A and 7B illustrate an example system for WLAN spatial nulling using independent sounding and a single NDP transmission;

FIG. 8 illustrates an example flowchart for joint precoder optimization;

FIG. 9 illustrates a flowchart of an example method for WLAN spatial nulling; and

FIG. 10 illustrates an example computing device.

### DETAILED DESCRIPTION

Beamforming, or multi-user (MU)-multiple-input and multiple-output (MIMO) precoding with spatial nulling may be a computationally demanding task. Therefore, low complexity precoding techniques with the best possible transmission performance may be beneficial. For best possible performance, a spatial nulling precoder computation between access points (APs) may be jointly optimized. Coordination messaging between APs may reduce efficiency and thus, it may be beneficial to minimize such messaging. Channel sounding may use airtime and/or may reduce the efficiency of the transmission scheme. Therefore, an efficient channel sounding technique that allows acquisition of the relevant channel information may be utilized.

In some previous approaches, investigation of spatial nulling may focus on zero-forcing precoding with independent precoder computation at each AP. Such approach may have low computational complexity, but may also include low performance. Joint sounding with two competing sounding sequences (e.g., one for each AP) may also be implemented, which may overcome the issue of communication over basic service set (BSS) boundaries. However, in such instances, the null data packets (NDPs) may be transmitted twice to avoid the requirement for STAs to receive null data packet announcement (NDPA) packets from un-associated APs. In some instances, it may be unknown how to communicate the channel feedback to the appropriate AP, which may need the channel feedback. Each station (STA) measures the channel from both APs, but each STA responds only to the associated AP.

To enable spatial nulling, channel estimation of the inter-BSS interference may be performed. Described herein are multi-AP sounding approaches for spatial nulling transmission. A first approach may be joint sounding, where both APs may send sounding packets at the same time. A second approach may be independent sounding, where the APs may send sounding packets at different times. Efficient implementations and/or joint precoder optimization for both approaches is discussed herein. In some instances, the present disclosure may facilitate a minimal message exchange between the BSS.

For joint sounding, a channel estimation exchange phase may be introduced to exchange the channel estimation information that may be used for spatial nulling between the APs. For independent sounding, the channel estimation information can be transmitted directly from the STAs to the associated AP, using appropriate settings. Spatial nulling may use coordination between simultaneously transmitting APs. The transmit precoders used by each of the APs may be aligned such that a receiver of the STA may be able to find a receive equalizer that may minimize interference from non-associated APs and may maximize signal quality for the reception from the associated AP.

The proposed sounding approaches may reduce inter-BSS communication and/or may minimize the time spent for the sounding procedure. Communication messages may be dedicated for a certain receiver (e.g., a STA or an AP), which may facilitate packing relevant information into the message and selecting appropriate transmission settings for a fast and secure transmission. Alternatively, or additionally, the proposed sounding procedures may enable a joint optimization of the precoding of the APs. Joint optimization of the precoding and spatial nulling of simultaneously transmitting APs may provide a performance improvement. The methods described herein may perform joint optimization of the precoding and spatial nulling of simultaneously transmitting APs and may maintain a low computational complexity with limited communication between the APs.

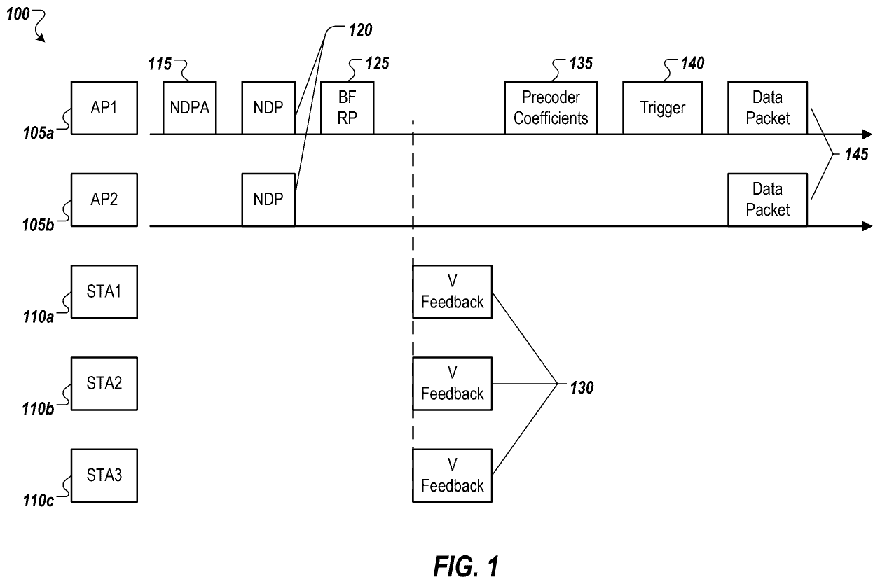

FIG. 1 illustrates an example system 100 implementing a joint sounding procedure. The system 100 may include a first AP 105a, a second AP 105b, referred to collectively as the APs 105, a first STA 110a, a second STA 110b, a third STA 110c, referred to collectively as the STAs 110, a NDPA transmission 115, NDP transmissions 120, a beamforming (BF) report poll (RP) 125, V feedback 130 (or sounding feedback 130), precoder coefficients 135, a trigger 140, and data packets 145.

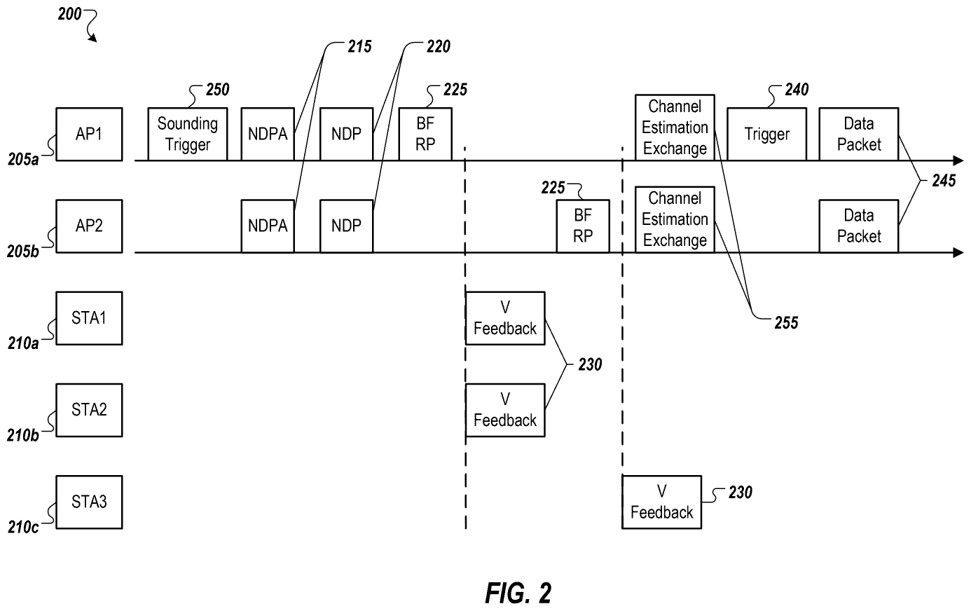

Similarly numbered reference numbers in the figures may represent the same of similar element, and/or may be operable to perform the same or similar operations. For example, the first STA 110a in FIG. 1 and the first STA 210a in FIG. 2 may be substantially the same STA and/or operable to perform substantially the same operations, unless stated otherwise.

In some instances, managing the sounding from the first AP 105a may avoid duplicating the NDP transmission 120 and/or reducing sounding overhead. Hereby, the NDP transmissions 120 and/or the sounding feedback 130 may be triggered by the first AP 105a. The second AP 105b (and/or additional APs not illustrated) may receive the precoder coefficients 135 for a nulling transmission. Alternatively, or additionally, the first AP 105a may send relevant feedback (e.g., a compressed feedback report for the relevant part of the channel and/or for the complete channel) to the second AP 105b and the second AP 105b may perform the precoder computation locally.

In some instances, a disadvantage of the system 100 illustrated in FIG. 1 may include STAs associated with the second AP 105b (e.g., the third STA 110c) may listen to messages from the first AP 105a. In such instances, the disadvantage may include an increased complexity and/or an increased power consumption for the STAs 110.

The procedure of the system 100 may allow the STAs 110 to communicate with their associated APs 105. In some instances, the procedure may not distribute the channel estimation feedback, as shown by the following example. A full channel with S=2 APs s=1, 2 and M=4 STAs m=1, . . . , M may be given by:

$$H = [ \begin{matrix}{G}_{1} {H}_{11} & {G}_{1} {H}_{12} \\ {G}_{2} {H}_{21} & {G}_{2} {H}_{22} \\ {G}_{3} {H}_{31} & {G}_{3} {H}_{32} \\ {G}_{4} {H}_{41} & {G}_{4} {H}_{42}\end{matrix} ]$$

with sub-matrices Hₘₛ. Assuming STAs m=1, 2 are associated with AP1 and STAs m=3, 4 are associated with AP2, the feedback given to AP1 (H₁₁, H₁₂ from STA1 and H₂₁, H₂₂ from STA2, shown in H below as bolded text) and the feedback for AP2 (H₃₁, H₃₂ from STA3 and H₄₁H₄₂ from STA4, shown in H below as non-bolded text) may be as follows:

$$H = [ \begin{matrix}{G}_{1} {H}_{11} & {G}_{1} {H}_{12} \\ {G}_{2} {H}_{21} & {G}_{2} {H}_{22} \\ {G}_{3} {H}_{31} & {G}_{3} {H}_{32} \\ {G}_{4} {H}_{41} & {G}_{4} {H}_{42}\end{matrix} ]$$

However, what may be needed for the spatial nulling precoder computation may be H₁₁ to H₄₁ for AP1 (the bolded elements of H) and H₁₂ to H₄₂ for AP2, or as illustrated below:

$$H = [ \begin{matrix}{G}_{1} {H}_{11} & {G}_{1} {H}_{12} \\ {G}_{2} {H}_{21} & {G}_{2} {H}_{22} \\ {G}_{3} {H}_{31} & {G}_{3} {H}_{32} \\ {G}_{4} {H}_{41} & {G}_{4} {H}_{42}\end{matrix} ]$$

As such, to provide appropriate feedback, AP1 may need G₃H₃₁ and G₄H₄₁ from AP2 and AP2 may need G₁H₁₂ and G₂H₂₂ from AP1.

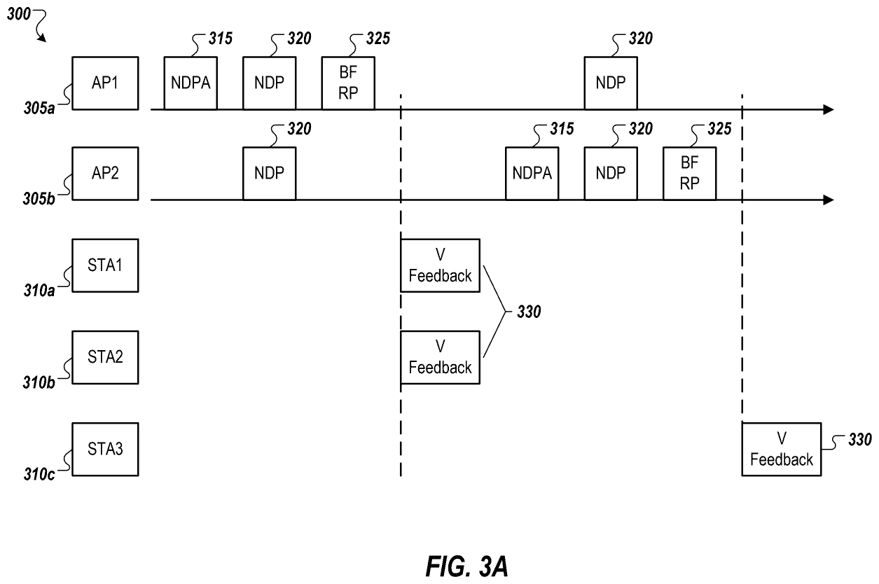

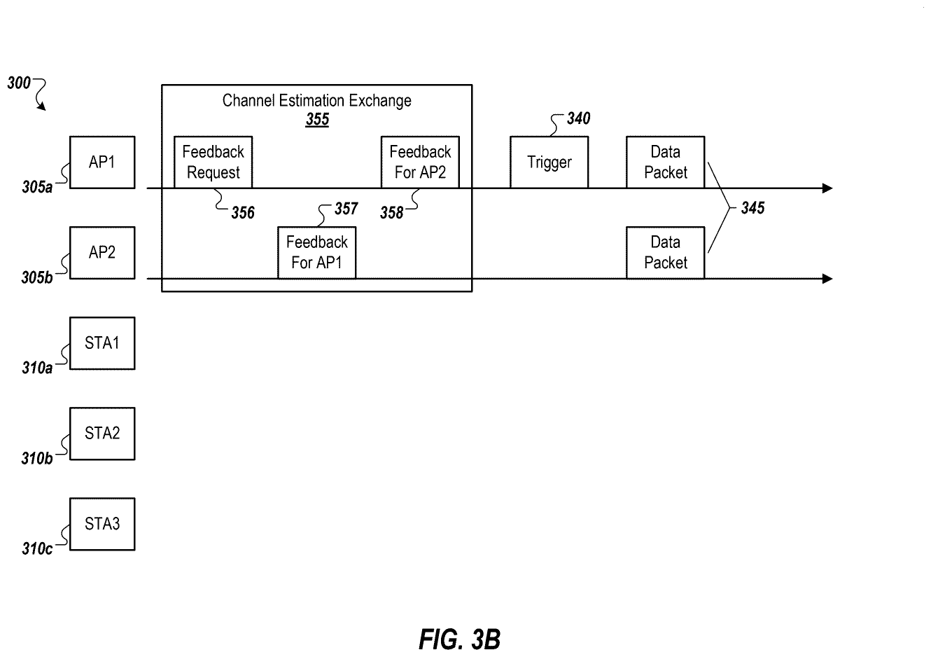

In some instances, each of the APs 105 may be operable to listen to feedback of the STAs 110 that may be associated and un-associated, such that each of the APs 105 may obtain the full channel information. Alternatively, or additionally, an exchange between the APs 105 may be performed in a channel estimation exchange phase, such as illustrated and described relative to FIGS. 2 and 3B.

FIG. 2 illustrates an example system 200 for WLAN spatial nulling using joint sounding with a single NDP transmission. The system 200 may include a first AP 205a, a second AP 205b, referred to collectively as the APs 205, a first STA 210a, a second STA 210b, a third STA 210c, referred to collectively as the STAs 210, a NDPA transmission 215, NDP transmissions 220, a BF RP 225, V feedback 230 (or sounding feedback 230), a precoder 235, a trigger 240, data packets 245 a sounding trigger 250, and a channel estimation exchange 255.

FIGS. 3A and 3B illustrate an example system 300 for WLAN spatial nulling using joint sounding with a double NDP transmission. The system 300 may include a first AP 305a, a second AP 305b, referred to collectively as the APs 305, a first STA 310a, a second STA 310b, a third STA 310c, referred to collectively as the STAs 310, a NDPA transmission 315, NDP transmissions 320, a BF RP 325, V feedback 330 (or sounding feedback 330), a precoder 335, a trigger 340, data packets 345, a sounding trigger 350, and a channel estimation exchange 355. The channel estimation exchange 355 may include a feedback request 356, first feedback 357, and second feedback 358.

FIG. 2 illustrates joint sounding procedures where the NDP transmission 220 and the sounding feedback 230 phase may be followed by a channel estimation exchange 255 phase between the APs 205. In some instances, the channel estimation exchange 255 may be implemented using a wired backhaul link between the APs 205. In such instances, no airtime may be needed for the channel estimation exchange 255.

In some instances, the system 200 may avoid a double NDP transmission 220 (e.g., as illustrated in FIGS. 3A and 3B) and may fulfill a requirement that the STAs 210 receive the NDPA transmissions 215 from the APs 205 associated with them. In such instances, the NDPA transmissions 215 from both of the APs 205 may be triggered by the first AP 205a. In such instances, a new trigger (e.g., the sounding trigger 250) operable to trigger the NDPA transmissions 215 may be used. Following the sounding trigger 250, the NDPA transmission 215 and NDP transmissions 220 may be transmitted.

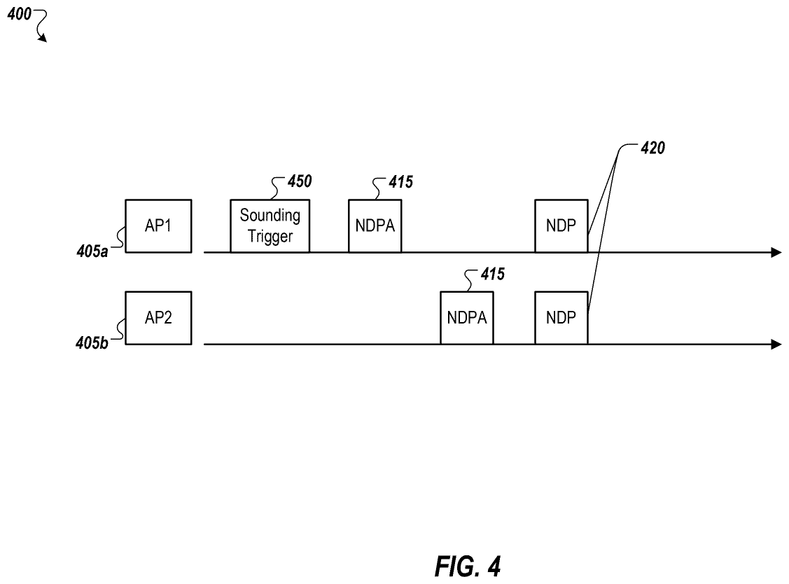

In instances in which spatial nulling is established, the NDPA transmissions 215 can be transmitted substantially simultaneously (e.g., such as illustrated in FIGS. 2 and 3A). Alternatively, or additionally, the NDPA transmissions 215 may be separated in time, such as illustrated relative to FIG. 4. FIG. 4 illustrates an example system 400 for a null data packet announcement (NDPA) trigger without spatial nulling. The system 400 include a first AP 405a, a second AP 405b, referred to collectively as the APs 405, a NDPA transmission 415, NDP transmissions 420, and a sounding trigger 450.

FIG. 3B illustrates details of the channel estimation exchange 355, where the first AP 305a may transmit the feedback request 356 to the second AP 305b, and the second AP 305b may respond by transmitting the first feedback 357 to the first AP 305a. The first AP 305a may also transmit the second feedback 358 to the second AP 305b, such that both of the APs 305 have the channel information.

In the channel estimation exchange 255, the first AP 205a may transmit the null steering vectors to the second AP 205b, and vice versa. In response to the second AP 205b receiving G₁H₁₂ and G₂H₂₂ from the first AP 205a and the second AP 205b having G₃H₃₂ and G₄H₄₂ from the associated STAs 210 feedback, the precoder for the second AP 205b may be determined by:

$${P}_{2 full} = {[ \begin{matrix}{G}_{1} {H}_{12} \\ {G}_{2} {H}_{22} \\ {G}_{3} {H}_{32} \\ {G}_{4} {H}_{42}\end{matrix} ]}^{H} {( {[ \begin{matrix}{G}_{1} {H}_{12} \\ {G}_{2} {H}_{22} \\ {G}_{3} {H}_{32} \\ {G}_{4} {H}_{42}\end{matrix} ] [ \begin{matrix}{G}_{1} {H}_{12} \\ {G}_{2} {H}_{22} \\ {G}_{3} {H}_{32} \\ {G}_{4} {H}_{42}\end{matrix} ]}^{H} )}^{- 1}$$

In some instances, the third and fourth precoder columns may be used for the second AP 205b precoding. Alternatively, or additionally, the precoder for the first AP 205a may be determined by the following, where the first and second precoder columns may be used for the first AP 205a precoding.

$${P}_{1 full} = {[ \begin{matrix}{G}_{1} {H}_{11} \\ {G}_{2} {H}_{21} \\ {G}_{3} {H}_{31} \\ {G}_{4} {H}_{41}\end{matrix} ]}^{H} {( {[ \begin{matrix}{G}_{1} {H}_{11} \\ {G}_{2} {H}_{21} \\ {G}_{3} {H}_{31} \\ {G}_{4} {H}_{41}\end{matrix} ] [ \begin{matrix}{G}_{1} {H}_{11} \\ {G}_{2} {H}_{21} \\ {G}_{3} {H}_{31} \\ {G}_{4} {H}_{41}\end{matrix} ]}^{H} )}^{- 1}$$

While the channel matrices Hₘₛ may be given by the physical channel, the receive equalizers Gₘ used to provide feedback to the other APs 205 can be optimized for the best overall performance. In some instances, the channel estimation exchange 255 may support the APs 205 handling communications between different BSSs, while AP-to-STA communication may be performed within the BSS. Alternatively, or additionally, the channel estimation exchange 255 may allow a joint precoder optimization (e.g., as described herein) which may provide improved performance. Alternatively, or additionally, the information exchange in the channel estimation exchange 255 may be dedicated for OBSS interference reduction. In some instances, a lower resolution of the feedback report can be used (e.g., a wider carrier grid and less bits per carrier than the regular V matrix feedback).

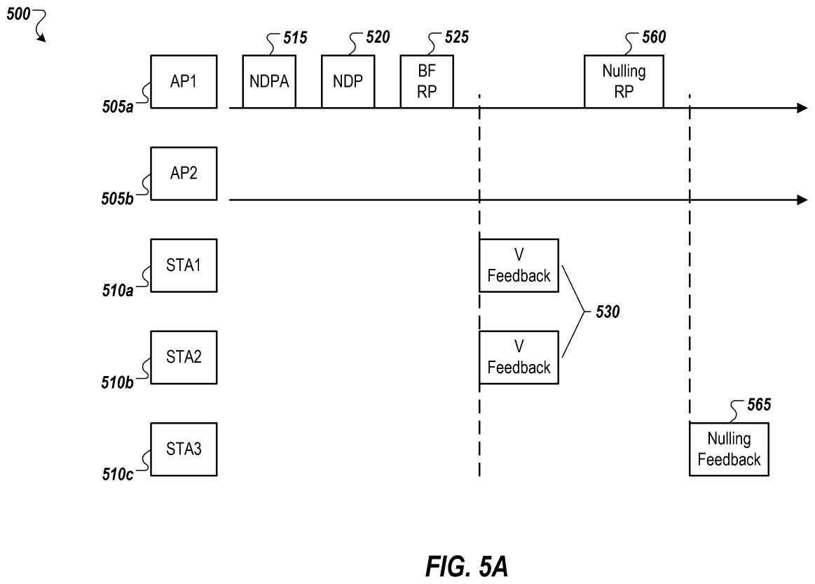

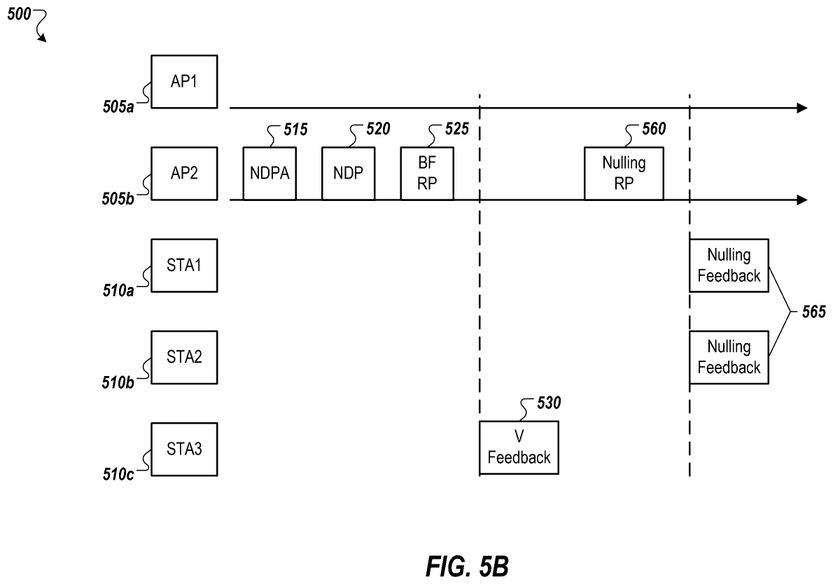

FIGS. 5A and 5B illustrate an example system 500 for WLAN spatial nulling using independent sounding. The system 500 may include a first AP 505a, a second AP 505b, referred to collectively as the APs 505, a first STA 510a, a second STA 510b, a third STA 510c, referred to collectively as the STAs 510, a NDPA transmission 515, NDP transmissions 520, a BF RP 525, nulling RP packets 560, and nulling feedback packets 565.

Independent sounding may be an alternative to joint sounding, where one of the APs 505 may be operable to transmit the NDP transmissions 520 at a time. As illustrated in FIGS. 5A and 5B, the STAs 510 may be operable to receive the NDPA transmission 515, the NDP transmissions 520, and/or the nulling RP packets 560 from the un-associated AP.

Joint sounding may provide new RP packets, the nulling RP packets 560 and new response packets, the nulling feedback packets 565, which may be transmitted in response to the nulling RP packets 560. The V feedback 530 may provide provides GₘHₘₛ of STA m, using the equalizer Gₘ that may be used for reception from AP s. Alternatively, or additionally, the nulling feedback packets 565 may provide GₘH_{md}, where the equalizer Gₘ may still the one used for reception from AP s (which may be kept in memory to provide the nulling feedback packets 565), but may be multiplied with the channel H_{md} from the un-associated AP d, which may be the AP that transmitted the sounding NDP transmissions 520.

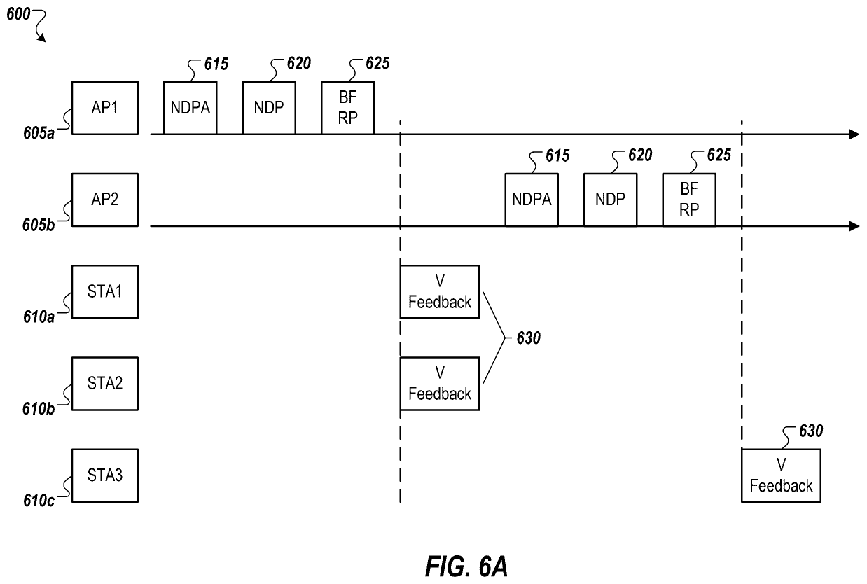

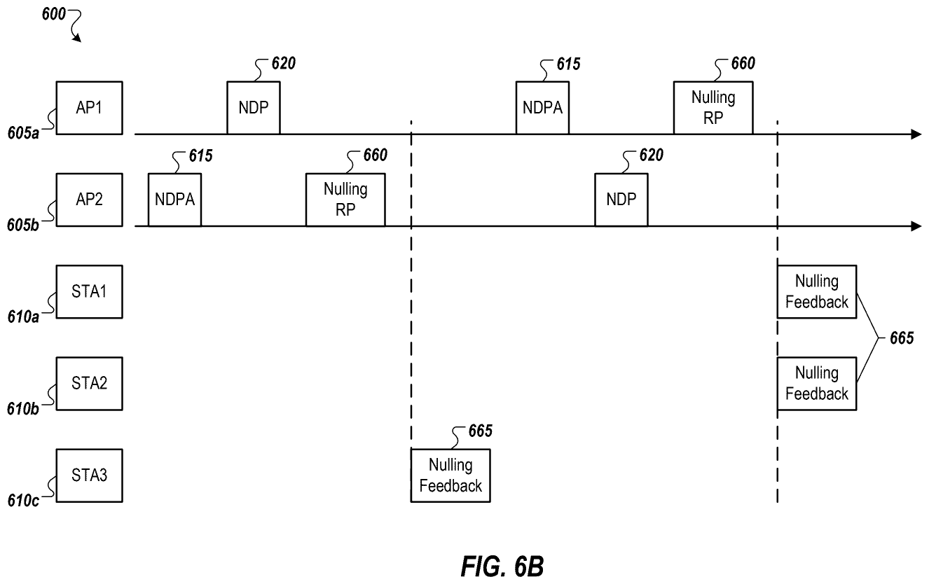

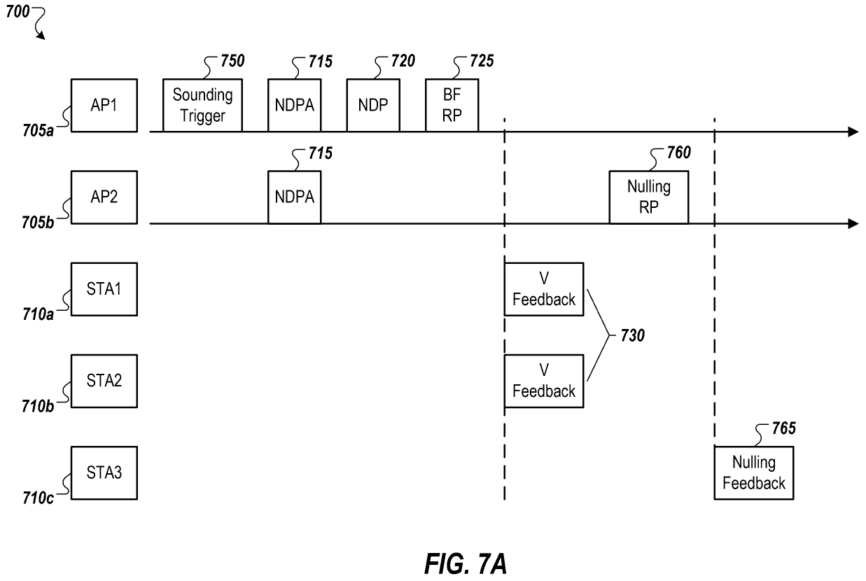

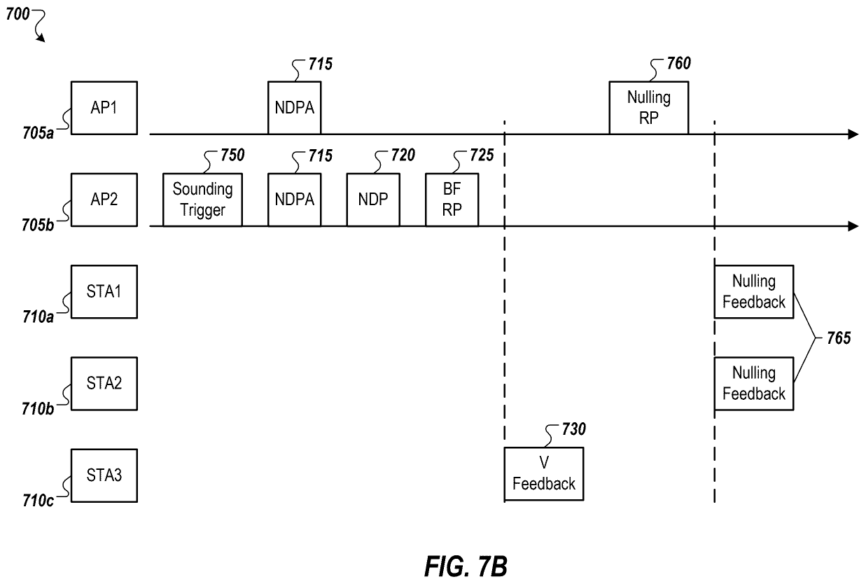

A disadvantage of the system 500 of FIGS. 5A and 5B may be a requirement for the STAs 510 associated with the second AP 505b to listen to messages from the first AP 505a. Such a circumstance may be a complexity and/or a power consumption disadvantage for the STAs 510. FIGS. 6A, 6B, 7A, and 7B . . . provide alternative implementations that may address the disadvantages of STAs listening to un-associated APs as described.

FIGS. 6A and 6B illustrate an example system 600 for WLAN spatial nulling using independent sounding and a double NDP transmission. The system 600 may include a first AP 605a, a second AP 605b, referred to collectively as the APs 605, a first STA 610a, a second STA 610b, a third STA 610c, referred to collectively as the STAs 610, a NDPA transmission 615, NDP transmissions 620, a BF RP 625, V feedback 630 (or sounding feedback 630), nulling RP packets 660, and nulling feedback packets 665.

FIGS. 7A and 7B illustrate an example system 700 for WLAN spatial nulling using independent sounding and a single NDP transmission. The system 700 may include a first AP 705a, a second AP 705b, referred to collectively as the APs 705, a first STA 710a, a second STA 710b, a third STA 710c, referred to collectively as the STAs 710, a NDPA transmission 715, NDP transmissions 720, a BF RP 725, V feedback 730 (or sounding feedback 730), sounding trigger 750, nulling RP packets 760, and nulling feedback packets 765.

In some instances, the disadvantages of STAs (e.g., the STAs 610 and/or the STAs 710) listening to un-associated APs described relative to the system 500 of FIGS. 5A and 5B may be solved by sending the NDP transmissions 620 twice from each of the APs 605 (e.g., four transmissions in total), as illustrated relative to FIGS. 6A and 6B. Alternatively, or additionally, the NDP transmissions 720 may be transmitted once from each of the APs 705, as illustrated relative to FIGS. 7A and 7B. In either or both of the system 600 and the system 700, the nulling RP packets 760 may provide transmission settings for the nulling feedback packets 765, which may allow a robust and/or reliable transmission of the nulling feedback packets 765.

In some instances, the independent sounding, as described relative to FIGS. 5A, 5B, 6A, 6B, 7A, and 7B, may include a number of advantages relative to joint sounding. For example, different feedback reports may be used for different use cases. Such circumstances may allow a higher resolution to be used and/or a more frequent sounding for the sounding feedback (e.g., the V feedback 530, 630, and/or 730). The different feedback reports may also be used for MU-MIMO precoding. Alternatively, or additionally, the nulling feedback, which may be used for OBSS interference reduction, may be requested less frequently and/or at a lower resolution (e.g., less bits per carrier, larger frequency interpolation, etc.). In another example, no channel estimation exchange may be used between the APs. Alternatively, or additionally, the individual feedback packets may be transmitted to a particular, associated AP, which may allow more efficient transmission settings relative to the joint sounding.

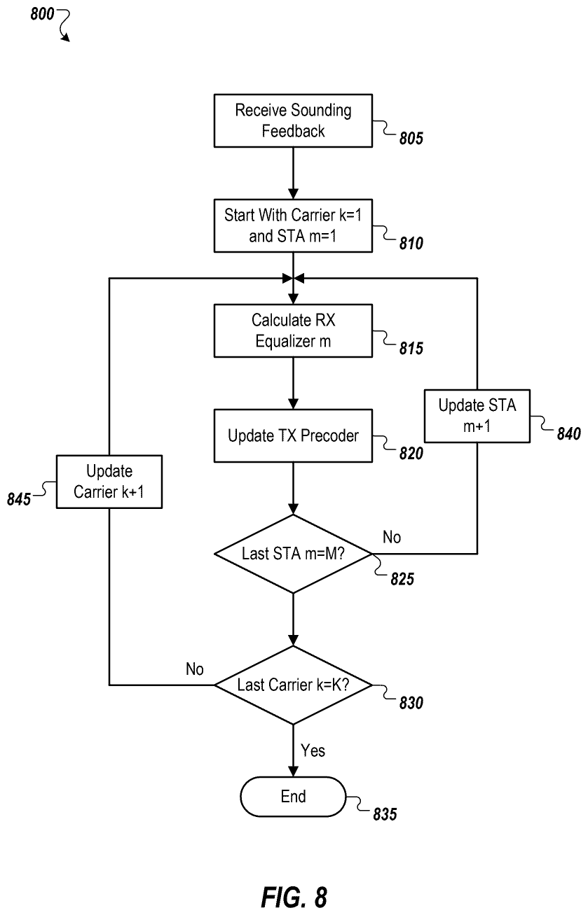

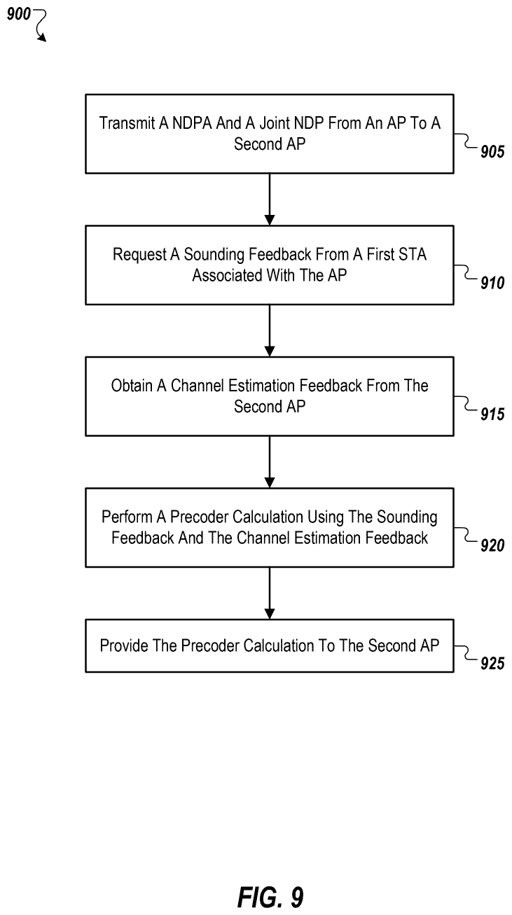

FIG. 8 illustrates a flowchart of an example method 800 for joint precoder optimization. FIG. 9 illustrates a flowchart of an example method 900 for WLAN spatial nulling. The methods 800 and 900 may be performed by processing logic that may include hardware (circuitry, dedicated logic, etc.), software (such as is run on a general purpose computer system or a dedicated machine), or a combination of both, which processing logic may be included in any computer system or device such as the first AP 105a and/or the second AP 105b of FIG. 1 (or any of the APs associated with the various figures described herein).

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

A particular STA m may report Gₘ [Hₘ₁Hₘ₂]. In some instances, the calculation may be performed based on a singular value decomposition of

$$[ {H}_{m 1} {H}_{m 2} ] = {U}_{m} {S}_{m} {V}_{m}^{H} .$$

### Assuming

$${G}_{m} = {S}_{m}^{- 1} {U}_{m}^{H} ,$$

then the feedback Gₘ [Hₘ₁Hₘ₂] may be equal to

$${V}_{m}^{H} .$$

Such result may be partitioned into

$${V}_{m}^{H} = [ {V}_{m 1}^{H} {V}_{m 2}^{H} ]$$

such that the precoder may be given by the following:

$${P}_{sfull} = {[ \begin{matrix}{V}_{1 s}^{H} \\ {V}_{2 s}^{H} \\ {V}_{3 s}^{H} \\ {V}_{4 s}^{H}\end{matrix} ]}^{H} {( {[ \begin{matrix}{V}_{1 s}^{H} \\ {V}_{2 s}^{H} \\ {V}_{3 s}^{H} \\ {V}_{4 s}^{H}\end{matrix} ] [ \begin{matrix}{V}_{1 s}^{H} \\ {V}_{2 s}^{H} \\ {V}_{3 s}^{H} \\ {V}_{4 s}^{H}\end{matrix} ]}^{H} )}^{- 1} .$$

In such instances, the interference between the APs may be eliminated. In some instances,

$${G}_{m} = {S}_{m}^{- 1} {U}_{m}^{H}$$

may not be optimal for the overall performance of the system. As illustrated, the optimization may be an iterative process, where Gₘ and Pₛ may be optimized jointly for all m=1, . . . , M and for s=1, 2. In some instances, the receive equalizers G_{opt,m} for jointly optimized precoding and equalization may be known and the feedback report from one AP to another AP may be done with the optimized precoder. For example, G_{opt,m}Hₘₛ may be reported to AP s in the corresponding feedback exchange phase with joint sounding. The method 800 in conjunction with FIG. 8 illustrate a flow diagram illustrating the iterative optimization.

The method 800 may begin at block 805 where sounding feedback may be received.

At block 810, a first carrier (e.g., k=1) and a first STA (e.g., m=1) may be determined.

At block 815, a receive equalizer may be calculated for the current iteration m of the STAs.

At block 820, a transmit precoder may be updated in response to the calculated receive equalizer.

At block 825, a determination as to whether the current m STA may be the last STA in the system may be made. In instances in which the m STA is not the last STA, the method 800 may proceed to block 840, where a next STA (e.g., STA m+1) may be selected. In instances in which the m STA is the last STA, the method 800 may proceed to block 830.

At block 830, a determination as to whether the current k carrier may be the last carrier in the system may be made. In instances in which the k carrier is not the last carrier, the method 800 may proceed to block 845, where a next carrier (e.g., carrier k+1) may be selected. In instances in which the k carrier is the last carrier, the method 800 may proceed to block 835.

At block 835, the method 800 may end and the joint precoder optimization may be complete, where the system may have an optimized joint precoder.

In an alternate implementation, independent sounding may be used. In such instances, the STA may use the receive equalizer from a previous transmission when requested, to generate the nulling feedback report. As such, the method 800 may be used with independent sounding to obtain an optimized precoding without additional steps.

The method 900 may begin at block 905 where a NDPA and a joint NDP may be transmitted from an AP to a second AP. In some instances, the NDPA may be transmitted by the AP at a first dedicated time slot and a second NDPA may be transmitted by the second AP at a second dedicated time slot.

At block 910, a sounding feedback may be requested from a first STA associated with the AP. In some instances, the second AP may request a second sounding feedback from a second STA associated with the second AP, and the second AP may determine the channel estimation feedback using the second sounding feedback.

At block 915, a channel estimation feedback may be obtained from the second AP. In some instances, the channel estimation feedback may include a feedback exchange packet obtained from the second AP. In some instances, the feedback exchange packet may include a different tone grouping and/or quantization bits relative to the sounding feedback. In some instances, the feedback exchange packet may be transmitted between the AP and the second AP via a non-wireless local area network link. Alternatively, or additionally, the feedback exchange packet may be transmitted between the AP and the second AP at a different time interval than transmission of the sounding feedback.

At block 920, a precoder calculation may be performed using the sounding feedback and the channel estimation feedback.

At block 925, the precoder calculation may be provided to the second AP.

Modifications, additions, or omissions may be made to the method 900 without departing from the scope of the present disclosure. For example, the designations of different elements in the manner described is meant to help explain concepts described herein and is not limiting. Further, the method 900 may include any number of other elements or may be implemented within other systems or contexts than those described.

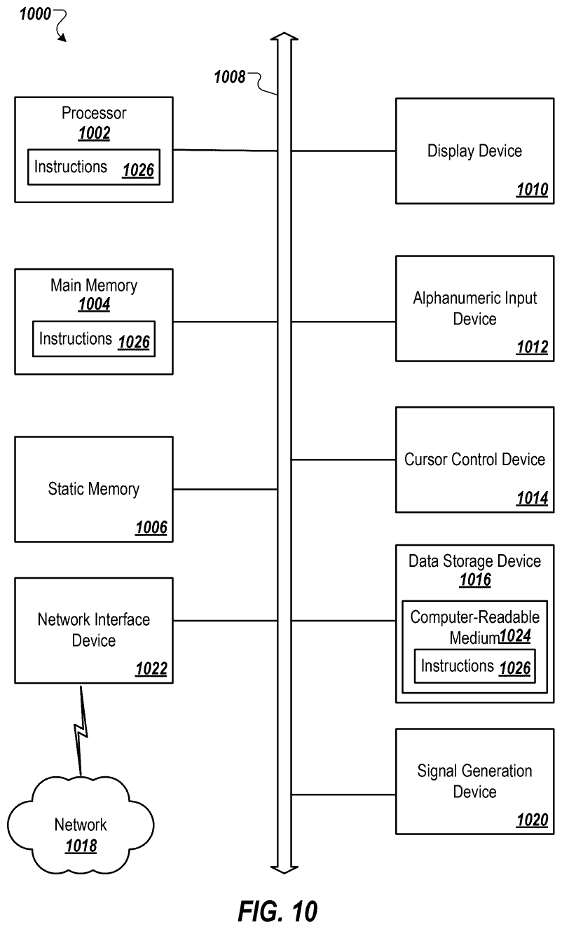

FIG. 10 illustrates an example computing device 1000 within which a set of instructions, for causing the machine to perform any one or more of the methods discussed herein, may be executed. The computing device 1000 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 1000 includes a processing device 1002 (e.g., a processor), a main memory 1004 (e.g., read-only memory (ROM), flash memory, dynamic random access memory (DRAM) such as synchronous DRAM (SDRAM)), a static memory 1006 (e.g., flash memory, static random access memory (SRAM)) and a data storage device 1016, which communicate with each other via a bus 1008.

The processing device 1002 represents one or more general-purpose processing devices such as a microprocessor, central processing unit, or the like. More particularly, the processing device 1002 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also include one or more special-purpose processing devices such as an application specific integrated circuit (ASIC), a field programmable gate array (FPGA), a digital signal processor (DSP), network processor, or the like. The processing device 1002 is configured to execute instructions 1026 for performing the operations and steps discussed herein.

The computing device 1000 may further include a network interface device 1022 which may communicate with a network 1018. The computing device 1000 also may include a display device 1010 (e.g., a liquid crystal display (LCD) or a cathode ray tube (CRT)), an alphanumeric input device 1012 (e.g., a keyboard), a cursor control device 1014 (e.g., a mouse) and a signal generation device 1020 (e.g., a speaker). In at least one implementation, the display device 1010, the alphanumeric input device 1012, and the cursor control device 1014 may be combined into a single component or device (e.g., an LCD touch screen).

The data storage device 1016 may include a computer-readable storage medium 1024 on which is stored one or more sets of instructions 1026 embodying any one or more of the methods or functions described herein. The instructions 1026 may also reside, completely or at least partially, within the main memory 1004 and/or within the processing device 1002 during execution thereof by the computing device 1000, the main memory 1004 and the processing device 1002 also constituting computer-readable media. The instructions may further be transmitted or received over the network 1018 via the network interface device 1022.

While the computer-readable storage medium 1024 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. An access point (AP), comprising:
a transceiver operable to communicate with at least a second AP and at least a first station (STA);
a processing device operable to:
transmit a null data packet announcement (NDPA) and a joint null data packet (NDP) from the AP and the second AP;
request a sounding feedback from the first STA;
obtain a channel estimation feedback from the second AP;
perform a precoder calculation using the sounding feedback and the channel estimation feedback; and
provide the precoder calculation to the second AP.

2. The AP of claim 1, wherein the NDPA is jointly transmitted at the same time by the AP and the second AP.

3. The AP of claim 1, wherein the NDPA is transmitted by the AP at a first dedicated time slot and a second NDPA is transmitted by the second AP at a second dedicated time slot.

4. The AP of claim 1, wherein the second AP requests a second sounding feedback from a second STA associated with the second AP, and the second AP determines the channel estimation feedback using the second sounding feedback.

5. The AP of claim 1, wherein the channel estimation feedback comprises a feedback exchange packet obtained from the second AP.

6. The AP of claim 5, wherein the feedback exchange packet comprises a different tone grouping and quantization bits relative to the sounding feedback.

7. The AP of claim 5, wherein the feedback exchange packet is transmitted between the AP and the second AP via a non-wireless local area network link.

8. The AP of claim 5, wherein the feedback exchange packet is transmitted between the AP and the second AP at a different time interval than transmission of the sounding feedback.

9. An access point (AP), comprising:
a transceiver operable to communicate with at least a second AP and at least a first station (STA);
a processing device operable to:
transmit a first NDPA and a first NDP from the AP;
obtain a sounding feedback from the first STA in response to the first NDPA and the first NDP;
transmit a nulling report poll (RP) to a second STA;
obtain a first nulling feedback from the second STA in response to the nulling RP;
cause a transmission of a second NDPA and a second NDP from the second AP, wherein the second AP obtains a second channel estimation feedback from the second STA and a second nulling feedback from the first STA; and
determine an equalizer for the first STA based on the sounding feedback, the first nulling feedback, the second channel estimation feedback, and the second nulling feedback.

10. The AP of claim 9, wherein the first NDPA and the second NDPA are jointly transmitted at the same time by the AP and the second AP.

11. The AP of claim 9, wherein the first STA listens to packets from the AP and not the second AP, and the second STA listens to packets from the second AP and not the AP.

12. The AP of claim 9, wherein the first nulling feedback is transmitted with a different tone grouping and quantization bits than transmission of the sounding feedback.

13. The AP of claim 9, wherein the first nulling feedback is transmitted at a different time interval than transmission of the sounding feedback.

14. The AP of claim 9, wherein the nulling RP comprises transmit precoding operable to improve mutual nulling between the AP and the second AP.

15. A method, comprising:
transmitting a null data packet announcement (NDPA) and a joint null data packet (NDP) from an access point (AP) to a second AP;
requesting a sounding feedback from a first station (STA) associated with the AP;
obtaining a channel estimation feedback from the second AP;
performing a precoder calculation using the sounding feedback and the channel estimation feedback; and
providing the precoder calculation to the second AP.

16. The method of claim 15, wherein the NDPA is transmitted by the AP at a first dedicated time slot and a second NDPA is transmitted by the second AP at a second dedicated time slot.

17. The method of claim 15, wherein the second AP requests a second sounding feedback from a second STA associated with the second AP, and the second AP determines the channel estimation feedback using the second sounding feedback.

18. The method of claim 15, wherein:
the channel estimation feedback comprises a feedback exchange packet obtained from the second AP; and
the feedback exchange packet comprises a different tone grouping and quantization bits relative to the sounding feedback.

19. The method of claim 18, wherein the feedback exchange packet is transmitted between the AP and the second AP via a non-wireless local area network link.

20. The method of claim 18, wherein the feedback exchange packet is transmitted between the AP and the second AP at a different time interval than transmission of the sounding feedback.
